(19) United States
(12) Patent Application Publication
(10) Pub. No.: US 2011/0313928 A1
(43) Pub. Date: Dec. 22, 2011

(54) METHOD AND SYSTEM FOR HEALTH INFORMATION EXCHANGE BETWEEN SOURCES OF HEALTH INFORMATION AND PERSONAL HEALTH RECORD SYSTEMS

(76) Inventor: Robert Blonchek, West Friendship, MD (US)

(21) Appl. No.: 12/819,306

(22) Filed: Jun. 21, 2010

(51) Int. Cl. G06Q 50/00; G06F 21/00

(52) U.S. Cl. 705/51; 705/3

(57) ABSTRACT

A method and system for exchanging health information of an individual via the Internet is characterized by tagging of discreet consumer health encounter records, created by an electronic medical record system, with a unique identification number and encoding the identification number in an electronically readable identifier. The record includes the results of medical examinations, medical procedures, medical device measurements and other health information pertinent to the individual. The record is tagged using an electronic network service that creates the unique identification number and the electronically readable identifier. When provided with the unique identification number and the electronically readable identifier, the individual can transfer private medical information to a selected personal health record system. This allows the transfer of private medical information in a secure manner without the need to connect the electronic medical record system to the personal health record system, and without the need for the patient to disclose where the medical information will be stored.

### FIELD OF THE INVENTION

The invention relates to a method and system for health information exchange, via the tagging, staging, and disconnected transmission of information associated with discreet health care encounters.

### BACKGROUND OF THE INVENTION

Electronic medical records (“EMR”) and personal health record (“PHR”) systems are now well known. Both EMRs and PHRs represent central repositories or sources of health information compiled about a specific individual. An EMR is typically established by a hospital or a physician and maintains a detailed health history of the individual as it relates to the care provided by the specific hospital or physician. A PHR is typically established by the individual as a means to store all relevant health-related information for the individual, regardless of the specific health care provider. The health information in a PHR may be collected from diverse sources, for example, information from health insurance providers, multiple EMRs being used by different providers providing care to the individual, medication records from pharmacies, information from labs and imaging centers, and direct input by the individual.

The trends in health care indicate that physicians are being challenged to adopt electronic medical records and to share more health information with individuals. In addition, as individuals become more aware of the need to take control of their own health in order to manage conditions/diseases, and as they become more aware of the challenges associated with the current healthcare delivery system and its associated costs, they are demanding easy, private, and portable access to their health information.

To address these needs, EMR and PHR systems are often connected together in order to facilitate the electronic exchange of health information over the Internet or other computer network. For example, U.S. Pat. No. 7,578,432 describes a method for transmitting medical information identified by a unique identifier barcode to a hospital, doctor's office or heath care facility. However, simply collecting patient information in a central repository through electronic or manual techniques, providing mechanisms to control access to the information, and interconnecting these systems does not adequately address the individual patient's need for easy, private, and portable access to personal health information (“PHI”). In fact, current approaches are limiting individual choice.

As the number of systems storing PHI grows, the number of connections between these systems, and the overhead burden of managing and maintaining these connections grow exponentially, quickly becoming unmanageable for both health care providers and individuals. For example, there are dozens of PHR systems currently available, with more becoming available every day. A health care provider cannot reasonably be expected to manage connections to all of the PHR solutions that may be used by the total population of the provider's patients. Also, the technical challenge associated with exchanging health information with a variety of different systems is often insurmountable for many health care organizations. As such, providers often restrict the number of PHR systems they support, which limits patient choice. A side-effect of the decision to restrict choice is that patients are required to disclose where they store and maintain their personal health information to health care providers, which reduces individual privacy.

In light of the above, what is needed is an improved system and method for consumer health information exchange that allows consumers to easily and securely upload personal health information to a personal health record or other personal health management service.

### SUMMARY OF THE INVENTION

Accordingly, it is a primary object of the invention to provide a method and system which allows an individual patient to cause the transfer of health information stored in a health information system such as an EMR, to a PHR or other private file, database, or repository chosen by and controlled by such individual, without the need to connect the systems together, and without the need for the patient to disclose where his information will be stored and maintained. Methods and systems are also disclosed for tagging and staging the health information associated with an individual's discreet health care encounters with a Unique Identification Number (“UIN”), and encoding the UIN in an Electronically Readable Identifier (“ERI”).

A UIN is a string of Base 64-encoded characters that is calculated using a cryptographic hash function operating on a globally unique identifier (“GUID”). A GUID is a 128-bit integer (16 bytes) that can be used across all computers and networks, with a very low probability of being duplicated. An ERI is a high capacity barcode that employs different symbol shapes in geometric patterns and/or multiple colors to provide more information in less space than traditional barcodes.

According to the invention, an EMR system, or other information system, implements individual health information exchange by tagging discreet consumer health encounter records (“HER”), such as office visits, lab tests, treatments, or procedures, with a UIN. The UIN is created through the use of a web service accessible via the Internet, using a Representational State Transfer (“REST”) interface, sometimes referred to as a “RESTful” interface. A RESTful interface is a style of software architecture for web services, built around the transfer of representations of resources, where a resource is any coherent and meaningful concept that may be addressed.

The web service stores the HER in a staging database and returns the UIN to the EMR. The HER does not contain identifying information for the individual, and is encrypted using the Data Encryption Standard (“DES”) algorithm before it is staged, thus enhancing the security and privacy of the individual's health information.

The web service also returns an ERI to the EMR system that contains the UIN and a Uniform Resource Identifier (“URI”). The identifier is a string of characters used to identify a resource on the Internet for another REST-based web service that is designed to transmit the health information from the staging database to an individual-chosen PHR system or other online health management service that provides an application programming interface (“API”) for receiving health information formatted as an Extensible Markup Language (“XML”) document. XML is a set of rules for encoding documents. In the invention, the XML rules are consistent with health care industry standards including the Continuity of Care Record (“CCR”) format, and the Continuity of Care Document (“CCD”) format, as well as proprietary XML formats provided by specific PHR systems or other health management services. Health management services include any health, wellness, or fitness website or web service that individuals use to store, manage, and analyze health information.

The UIN and ERI are physically provided to the individual by the health care provider by printing them on a variety of health documents such as discharge instructions or account summaries, or by delivering them electronically to the individual by electronic mail or other electronic mechanism.

The individual scans the ERI using a standard smart phone or other mobile device equipped with a camera, an Internet connection, and image-processing software that decodes the ERI. Alternatively, the individual uses a standard Internet browser to enter the UIN at a website. These actions cause the transmission of the staged health information from the staging database to the PHR system or other health management system using the web service identified by the URI encoded in the ERI as described above. The transmission of the staged information occurs directly between the web service and the PHR system or other health management system, thus eliminating the need to directly connect the EMR and PHR systems together, and allowing the information to be transmitted without the need for the individual to disclose where it will be stored.

The result is a highly-scalable and flexible, individual-controlled health information exchange system that enables easy, private and portable exchange of individual health information between any EMR or other health information system and any number of PHR systems or other health management systems.

Other embodiments of the invention use the same methods to provide individual health information exchange using communications-equipped medical devices, such as blood pressure monitors, glucose monitors, and weight scales, as well as from the entry of microsyntax commands by an individual using a standard Internet browser, where microsyntax commands are conventions or information patterns that represent individual health information.

### BRIEF DESCRIPTION OF THE FIGURES

FIG. 1 is a flow chart showing the steps taken to stage individual health information in the staging database;

FIG. 2 is a flow chart showing the steps taken to transmit the individual health information in the staging database to the destination PHR;

FIG. 3 is a flow chart showing the steps involved in connecting a medical device to a PHR using the same methods disclosed by the invention; and

FIG. 4 is a flow chart showing the steps involved in a patient entering microsyntax commands to transfer health information using the same methods disclosed by the invention.

### DETAILED DESCRIPTION

The present invention relates to methods and systems which allow the tagging, staging and transmission of a HER, that represent the data associated with a discrete health encounter for an individual, stored in a health information system such as an EMR, to a PHR or other private file, database or repository chosen by and controlled by such individual, without the need to directly connect the systems together. By tagging and transmitting a discreet HER, the individual is provided with easy, private, and portable access to the individual's personal health information, and he or she can store that information in any number of PHR solutions or other health management systems (“HMS”) without the need to disclose where the data is stored to any health care provider or other entity within the healthcare industry.

The terms individual, patient, and user will be used interchangeably herein. However, it is important to note that a patient need not be an individual with an illness, disease, or other pre-existing condition.

Health encounters include, for example, medical examinations at a physician's office, a hospital emergency room visit, the fulfillment of a prescription at a pharmacy, a weigh-in using a weight scale and/or body analyzer, a medical procedure performed at a clinic, hospital or doctor's office, the production of an individual's complete medical record, or a health insurance transaction to effect payment for a health encounter.

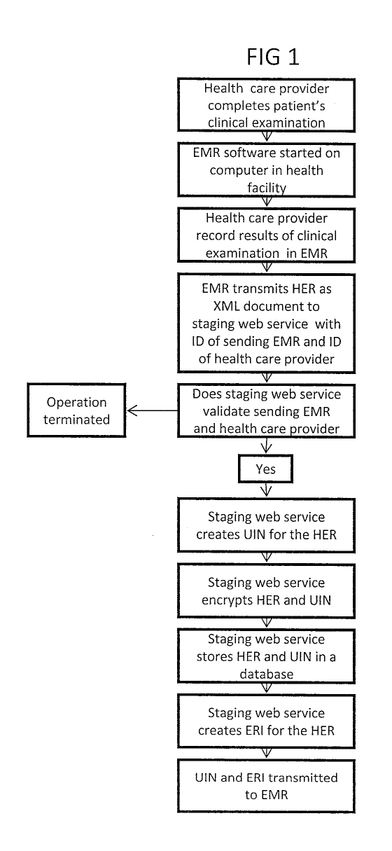

As shown in FIG. 1, once a physician or other health care provider completes an individual's clinical examination or procedure he, or another member of the medical staff, records the results of the examination in an EMR accessible via a computer in the health care facility where the examination or treatment is taking place. The results may include lab tests performed, diagnosis, treatment plans, prescriptions for medications, etc. When directed by the health care provider or other staff, the EMR system creates an XML document representation of the health information associated with the health encounter. The XML document adheres to the Continuity of Care Record (CCR) standard, the Continuity of Care Document (CCD) standard or other proprietary XML format.

Once the XML document for the HER is prepared, the EMR system transmits the HER along with unique identifiers representing the sending EMR system and identifying the physician, health care facility, medical practice, or other organizational unit that is providing health care services to the individual, to a staging web service using a RESTful interface.

When the staging web service receives the HER and the unique identifiers, it validates that the sending EMR and health care provider are authorized to connect to the web service. If either the sending EMR or health care provider is unauthorized, the staging request is rejected and the sending EMR system is notified of the error condition.

Once the sending EMR and health care provider are authenticated, the staging web service creates a UIN for the HER.

A UIN is a string of Base 64-encoded characters that is calculated using a cryptographic hash function operating on a globally unique identifier (“GUID”). A GUID is a 128-bit integer (16 bytes) that can be used across all computers and networks, with a very low probability of being duplicated. It is created by combining a unique place, represented by the network media access control (“MAC”) address of the computer creating the GUID, and a unique instant in time expressed as the current date and time of day.

The staging web service next encrypts the HER using the DES algorithm and stores the encrypted HER along with the UIN in a staging database.

The staging web service then creates an ERI for the HER by encoding a URI for a web service that is designed to transmit the HER to a PHR system, in a two-dimensional, high capacity barcode. The URI includes a query string parameter that is the UIN after being encrypted using the DES algorithm.

An ERI is a high capacity barcode that employs different symbol shapes in geometric patterns and/or multiple colors to provide more information in less space than traditional barcodes.

Finally, the staging web service transmits the UIN and ERI to the EMR system.

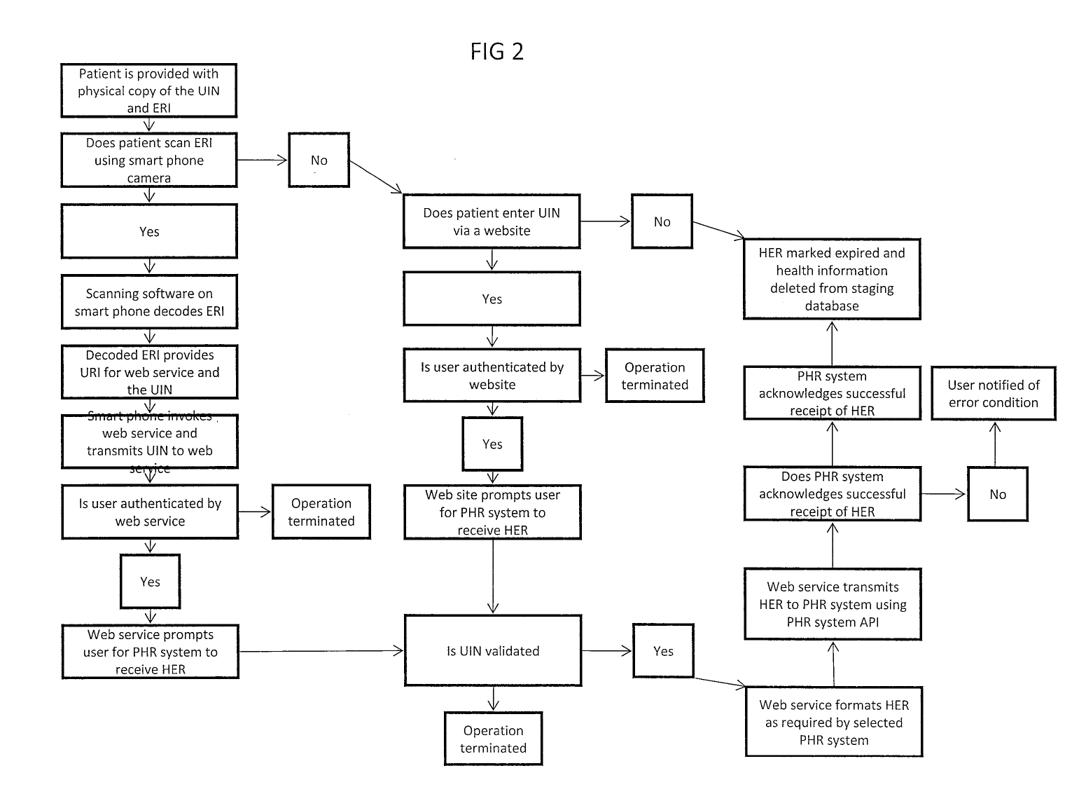

As shown in FIG. 2, the individual is provided with a physical copy of the UIN and ERI. This can be accomplished in multiple ways including printing the barcode image and UIN character string on a variety of health documents such as discharge instructions or account summaries, or the UIN and ERI can be sent to the individual electronically using electronic mail or other mechanism. Other approaches include displaying the UIN and/or ERI to the individual using a display device or kiosk located in the health facility where the individual is receiving medical treatment or services.

Once the individual has physical custody of the UIN and EIN, he may use one of two options to affect the transfer of the health information to the individual's choice of PHR system. The individual may use the camera on a smart phone or other mobile device to scan the ERI. Image-processing software on the mobile device decodes the barcode image and extracts the URI, which includes the encrypted UIN, from the ERI. The mobile device then invokes a web service using the URI via an Internet browser installed on the mobile device, which has the effect of transmitting the UIN of the HER to the web service.

The web service authenticates the individual and prompts the individual for the correct PHR system that will receive the HER. If the individual is not authenticated the operation is terminated.

The individual may also enter the UIN at a website to transfer the health information to the individual's choice of PHR system. The website authenticates the individual and prompts the individual for the correct PHR system that will receive the HER. If the individual is not authenticated the operation is terminated.

If the individual does not scan the ERI with a mobile device or enter the UIN at a website, the HER will expire after a period of time and the associated health information is deleted from the staging database.

When the individual is authenticated, the web service decrypts the UIN and validates that a HER with the corresponding UIN is staged in the staging database. If the HER is not found, the operation is terminated.

The web service formats the HER as required by the selected PHR system or other HMS. In some embodiments of the invention, the formatted HER is an XML document that adheres to industry standards such as the CCR and CCD XML formats. In other embodiments, the formatted HER adheres to a proprietary format required by the destinations PHR system. The proprietary format may be an XML format, or may be a JavaScript Object Notation (JSON) format, which is a lightweight data-interchange format based on a subset of the JavaScript programming language.

The formatted HER is transmitted to the destination PHR system or other HMS using an API provided by the destination system. The destination system acknowledges the successful receipt and processing of the HER which signals to the web service that the HER has reached its intended destination. The web service then marks the HER as expired and deletes the associated health information from the staging database, further ensuring the privacy of the individual's health information.

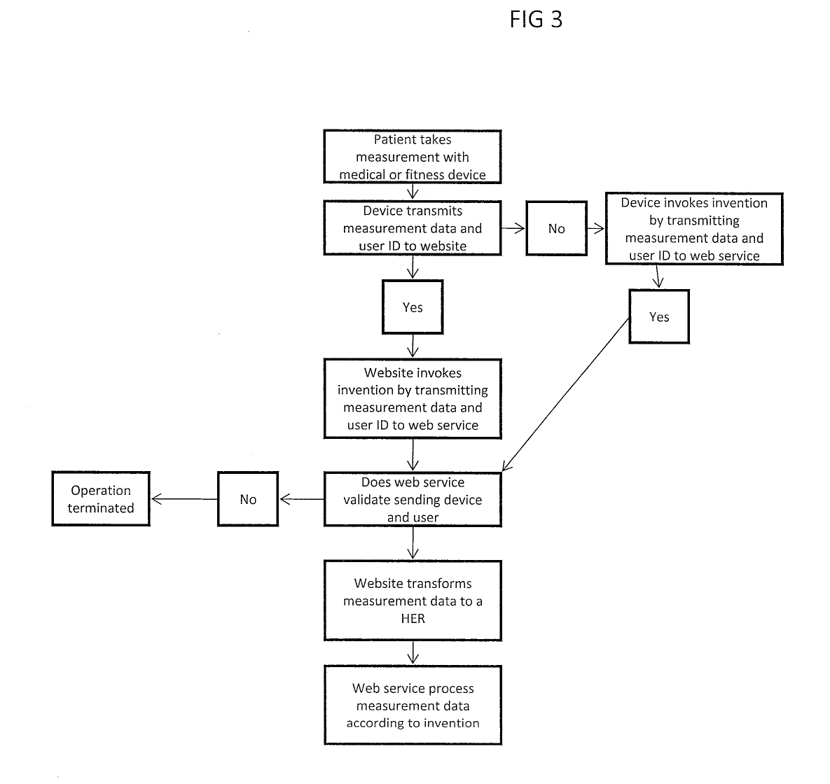

As shown in FIG. 3, a communications-equipped medical or fitness device such as a blood pressure monitor, a glucose monitor, a weight scale, or a pedometer may transmit measurement data to a website or other software component accessible over a computer network or the Internet, that then invokes the invention by transmitting the measurement data, along with an identification number identifying the individual user of the device, to yet another web service via a RESTful interface. In another embodiment of the invention, the medical device may invoke the invention directly by transmitting measurement data and the individual identification number directly to the web service via a RESTful interface.

The web service authenticates the device and the individual and if not authenticated the operation is terminated. If the device and individual are authenticated, the web service transforms the measurement data into a HER and proceeds to stage the HER in the staging database as described above. The web service then formats the HER as required by the individual's choice of PHR system or other HMS to receive the HER, and proceeds to transmit the HER to the destination system as previously disclosed.

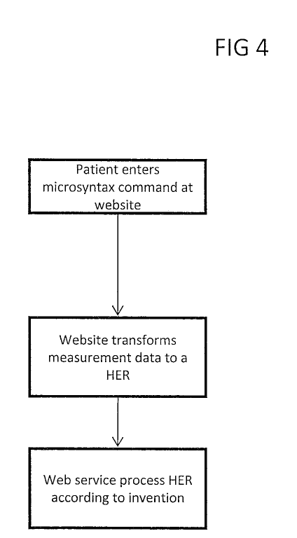

In another embodiment of the invention, as shown in FIG. 4, the individual enters a microsyntax command using a standard Internet browser, where microsyntax commands are conventions or information patterns that represent individual health information. An example of a microsyntax command is: “bp117d77p80” which represents a blood pressure measurement that includes systolic pressure, diastolic pressure, and pulse. The website transforms the microsyntax information into a HER and then proceeds to stage the HER in the staging database as disclosed by the invention. The web service then formats the HER as required by the individual's choice of PHR system or other HMS to receive the HER, and proceeds to transmit the HER to the destination system as previously disclosed.

Other variations and modifications are possible which remain in the concept, scope, and sprit of the invention, and these variations would become clear to those of ordinary skill in the art. Accordingly, the present embodiments are to be considered illustrative and not restrictive, and the invention is not to be limited to the details given herein, but may be modified within the scope of the appended claims.

1. A method for exchanging health information, comprising the steps of
(a) creating a health encounter record for an individual;
(b) recording the health encounter record in an electronic medical record system;
(c) transmitting the health encounter record with a unique identifier representing the electronic medical record system and the health care provider to an electronic network service; and
(d) validating the authorization of the electronic medical record system and health care provider for connection with the electronic network service.

2. A method as defined in claim 1, wherein the health encounter record includes at least one of the results of a medical examination, the results of medical testing, and prescription information.

3. A method as defined in claim 1, wherein said unique identifier includes information relating to at least one of a particular physician, a particular medical facility, and the electronic medical record system.

4. A method as defined in claim 2, wherein said health encounter record is transmitted as extensible markup language.

5. A method as defined in claim 1, and further comprising the step of creating a unique identification number for the health encounter record.

6. A method as defined in claim 5, and further comprising the step of encrypting the health encounter record and the unique identification number.

7. A method as defined in claim 5, where said encrypting step is performed using a data encryption standard algorithm.

8. A method as defined in claim 6, and further comprising the step of storing the encrypted health encounter record and unique identification number in a database.

9. A method as defined in claim 6, and further comprising the step of creating an electronically readable identifier for the encrypted health encounter record and the unique identification number.

10. A method as defined in claim 9, wherein said electronically readable identifier comprises a barcode.

11. A method as defined in claim 9, and further comprising the step of transmitting the unique identification number and the electronically readable identifier to an electronic medical record system.

12. A method as defined in claim 10, and further comprising the step of printing a copy of said barcode for presentation to the individual so that the individual has an encoded copy of the health encounter record.

13. A method as defined in claim 12, and further comprising the step of scanning said copy to decode the barcode image and extract the unique identification number.

14. A method as defined in claim 13, wherein said unique identification number for the health encounter record is transmitted via an electronic network.

15. A method as defined in claim 14, wherein said electronic network comprises the Internet.

16. A method as defined in claim 13, and further comprising the step of authenticating the individual that scanned said barcode.

17. A method as defined in claim 14, and further comprising the step of prompting the individual to choose a personal health record system to store said copy of the health encounter record.

18. A method as defined in claim 14, and further comprising the step of validating that said unique identification number is valid.

19. A method as defined in claim 17, wherein the health encounter record is formatted in accordance with the personal health record system selected by the individual.

20. A method as defined in claim 19, and further comprising the step of transmitting said formatted health encounter record to the personal health record system selected by the individual.

21. A method as defined in claim 20, and further comprising the step of transmitting an acknowledgement that the selected personal health record system received said formatted health encounter record.

22. A method as defined in claim 21, and further comprising the step of removing the health encounter record from the database.

23. A method as defined in claim 1, and further comprising the step of processing a medical device measurement that represents health information of the individual.

24. A method as defined in claim 1, and further comprising the step of entering a microsyntax command that represents health information of the individual.
